(19) United States
(12) Patent Application Publication
(10) Pub. No.: US 2012/0212513 A1
(43) Pub. Date: Aug. 23, 2012

(54) Method Of Improving Operation Of Handheld Pointer Device In A Display Screen

(76) Inventors: Ching-Hung Tseng, Hsinchu (TW); Hsin-Po Wang, Hsinchu (TW)

(21) Appl. No.: 13/210,362

(22) Filed: Aug. 15, 2011

(30) Foreign Application Priority Data
Feb. 23, 2011 (TW) 100106031

(51) Int. Cl. G06F 3/033; G09G 5/373

(52) U.S. Cl. 345/661; 345/157

(57) ABSTRACT

A method of improving operation of handheld pointer device in a display screen is provided, applicable to a handheld pointer device and a display. The display can display a cursor indicating the location of a handheld pointer device in a display screen. The method includes the steps of: the handheld pointer device issuing a control signal to the display to enter a predefined mode; the display receiving the control signal and activating the predefined mode, the predefined mode including selecting a rectangular area inside the operation screen and the rectangular area being a partial area of the operation screen; the display in the predefined mode receiving and executing each of the control signals issued by the handheld pointer device; and determining whether to exit the predefined mode based on the execution result of previous step.

### FIELD OF THE INVENTION

The present invention generally relates to a method of improving operation in a display screen, and more specifically to a method of improving operation of a handheld pointer device in a display screen for easily selecting a target object in the display screen.

### BACKGROUND OF THE INVENTION

The various internet TV programs or interactive game stations developed recently usually use a display screen to show a view of operation screen and a handheld pointer device, such as, a light gun or air mouse, for remote operation and control. The handheld pointer device is used to select the target object in the operation view and select the functions associated with the target object. The target object can be an icon or a visual object displayed in the operation screen.

This type of handheld pointer device is handheld and operated in the air without placing on any auxiliary surfaces, such as, a desk surface. The operation is also from a distance of a few meters. Hence, the operation usually suffers trembling from user hand or caused by button pressing on the handheld pointer device. These trembling usually will affect the accurate pointing to the target object in the display screen, especially for smaller-size objects, and thus resulting in selecting the wrong object or taking longer time to select an object. This deficiency severely impedes the popularity and effectiveness of such applications. It is imperative devise a solution to overcome the above-mentioned deficiency.

### SUMMARY OF THE INVENTION

The primary object of the present invention is to provide a method of improving operation of handheld device in a display screen, by solving the trembling of the handheld pointer device caused by hand shaking for button pressing, resulting in degradation of accurate target selection.

Another object of the present invention is to provide a method of improving operation of handheld device in a display screen, by slowing the movement of the cursor within a rectangular area inside the operation screen. The rectangular area is an area within the original operation screen, and the cursor indicating the handheld pointer device will move slowly within the rectangular area so that the cursor can easily locate to select the target object located inside the rectangular area.

Yet another object of the present invention is to provide a method of improving operation of handheld device in a display screen, by enlarging a rectangular area inside the operation screen. The rectangular area is an area within the original operation screen, and the enlargement of the rectangular area also enlarges the target object shown in the rectangular area so that the cursor can easily locate to select the target object located inside the rectangular area.

To achieve the aforementioned objects, the present invention provides a method of improving operation of handheld pointer device in a display screen, applicable to a handheld pointer device and a display. The display can display a cursor indicating the location of a handheld pointer device in a display screen. The method includes the steps of: the handheld pointer device issuing a control signal to the display to enter a predefined mode; the display receiving the control signal and activating the predefined mode, the predefined mode including selecting a rectangular area inside the operation screen and the rectangular area being a partial area of the operation screen; the display in the predefined mode receiving and executing each of the control signals issued by the handheld pointer device; and determining whether to exit the predefined mode based on the execution result of previous step.

The aforementioned control signals issued by the handheld pointer device include executing a cursor slow movement mode, an enlargement mode or an exit the predefined mode. The slow movement mode will cause the cursor moving into the rectangular area inside the operation screen to move slowly so that will not be sensitive to the minor trembling of the user hand. The enlargement mode is to enlarge the contents of the rectangular area inside the operation screen so that the target object within the area is also enlarged for easy selection.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the operation of the method according to the invention;

FIG. 2 shows a flowchart of the method according to the present invention;

FIG. 3 shows a schematic view of executing a slow cursor movement mode in an operation screen executing a predefined mode;

FIG. 4A shows a schematic view prior to executing a slow cursor movement mode in an operation screen executing a predefined mode; and

FIG. 4B shows a schematic view of executing a slow cursor movement mode in an operation screen executing a predefined mode.

### DETAILED DESCRIPTION OF THE PREFERRED EMBODIMENTS

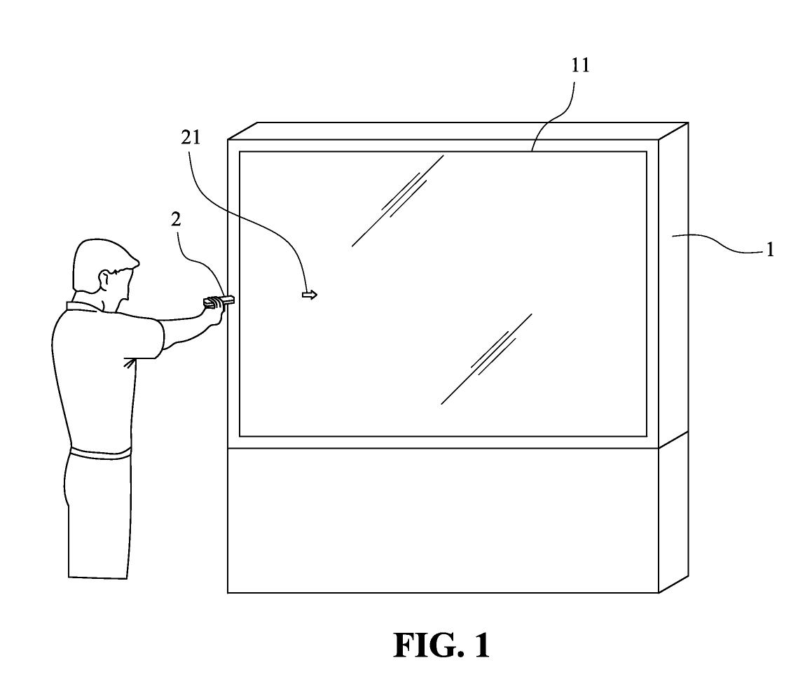

FIG. 1 shows a schematic view of the operation of the present invention in an applicable system according to the invention. The system includes a display 1 and a handheld pointer device 2. Display 1 can be connected through either built-in or externally added connection to sensor unit, computer host, related control unit, and so on, for receiving the signals or commands issued by handheld pointer device 2. Display 1 displays a related operation screen 11 and a cursor 21 indicating the location of handheld pointer device 2. Cursor 21 is to select a target object displayed in operation screen 11 and the operation function associated with the selected target object. Display 1 may be a TV, computer monitor or projection screen for projector.

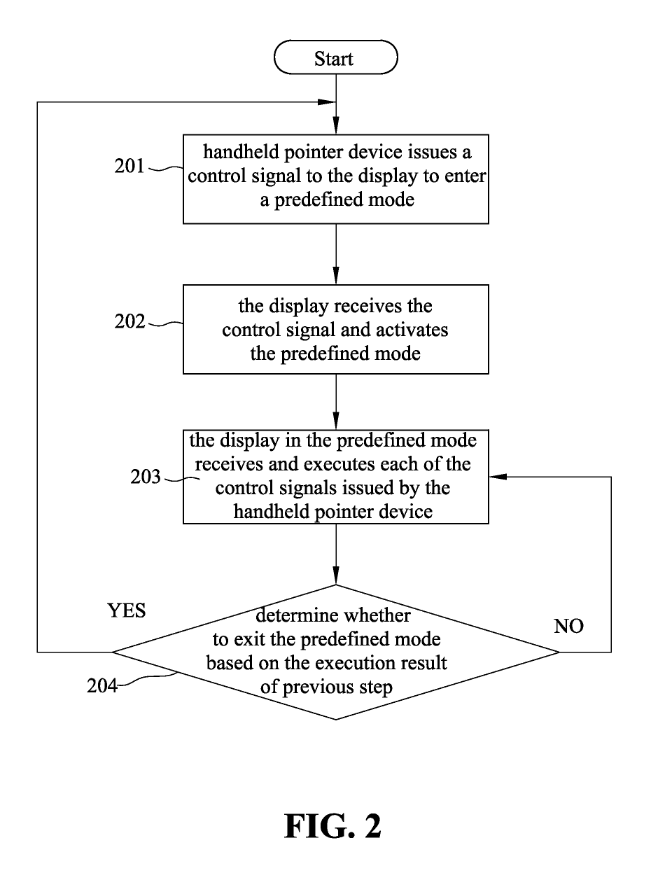

Handheld pointer device 2 does not need to be placed on any surface operate. Instead, handheld pointer device 2 is to be held in the air for operation, such as, a light gun or air mouse. The method of the present invention is to improve the problem that the operation usually suffers trembling from user hand or caused by button pressing on the handheld pointer device. These trembling usually will affect the accurate pointing to the target object in the display screen, especially for smaller-size objects, and thus resulting in selecting the wrong object or taking longer time to select an object. FIG. 2 shows a flowchart of the operation of the method of the present invention. As mentioned earlier, the display will display an operation screen with a cursor indicating the location of the handheld pointer device. The method of the present invention includes the following steps.

In step 201, the handheld pointer device issues a control signal for entering a predefined mode to the display.

In step 202, the display receives the control signal for entering a predefined mode from the handheld pointer device and activates the predefined mode. The predefined mode includes selecting a rectangular area inside the operation screen. The rectangular area is a partial area within the operation screen. The rectangular area covers the location of the cursor when the handheld pointer device issues the control signal.

In step 203, the display in the predefined mode receives and executes each of the control signals issued by the handheld pointer device.

In step 204, based on the execution result of the previous step, the display determines whether to exit the predefined mode. If yes, the display returns to the state prior to entering the predefined mode; otherwise, the display returns to step 203.

The following describes in details of each of the above steps. When the operation screen shown on the display shows the location of the cursor, the user can freely browse all the information shown in the operation screen. When the user finds a target object, the user can use the handheld device to move the cursor to approach the target object.

When the user moves the cursor to approach the target object, the user can execute step 201 to enable the handheld pointer device to issue a control signal for entering a predefined mode to the display.

When the display receives the control signal issued by the handheld pointer device in step 202, the display defines a rectangular area inside the operation screen. The size of the rectangular area can be predefined, such as, a 4×4 or 3×6 in area. The rectangular area must cover the location of the cursor as the reference base point when the handheld pointer device issues the control signal. The rectangular area must also cover the intended target object. The rectangular area can be either displayed or not displayed on the operation screen according to the predefined choice.

The predefined mode of the present invention includes setting the aforementioned rectangular area and executing a slow cursor movement mode or an enlargement mode, where the setting of the rectangular area is executed in step 202 while executing a slow cursor movement mode or an enlargement mode can be automatically performed in step 202 or performed in step 203 by another control signal from the handheld pointer device according to the design choice. The slow cursor movement mode is to slow down the movement of the cursor and the enlargement mode is to enlarge the selected rectangular area. Either mode can make the cursor easier to select the target object within the rectangular area so as to solve the problem that the operation usually suffers trembling from user hand or caused by button pressing on the handheld pointer device to affect the accurate pointing to the target object in the display screen. The details of both modes will be described momentarily.

In step 203, the handheld pointer device issues different types of control signals and the display receives the control signals to execute each mode or perform various adjustments. For example, the control signal is to adjust the rectangular area, such as, size, shape or location inside the operation screen. A control signal, for another example, is to activate or terminate the slow cursor movement mode. Another example of the control signal is to activate or terminate the enlargement mode. A control signal can also be used to adjust the enlargement ratio of the rectangular area. The control signals also include a control signal to indicate whether to exit the predefined mode.

In step 204, based on the execution result from step 203, the display determines whether to exit the predefined mode. The present invention exits the predefined mode only under the circumstance of two types of execution results. The first is the handheld pointer device issues a control signal to exit the predefined mode, and the display will execute the exiting of the predefined mode and return to the initial state. In other words, the rectangular area will disappear from the operation screen, and the operation screen will resume without the rectangular area. The second is the handheld pointer device issues a control signal to select a target object within the rectangular area. In this case, the display will execute the function associated with the selected target object and exit the predefined mode.

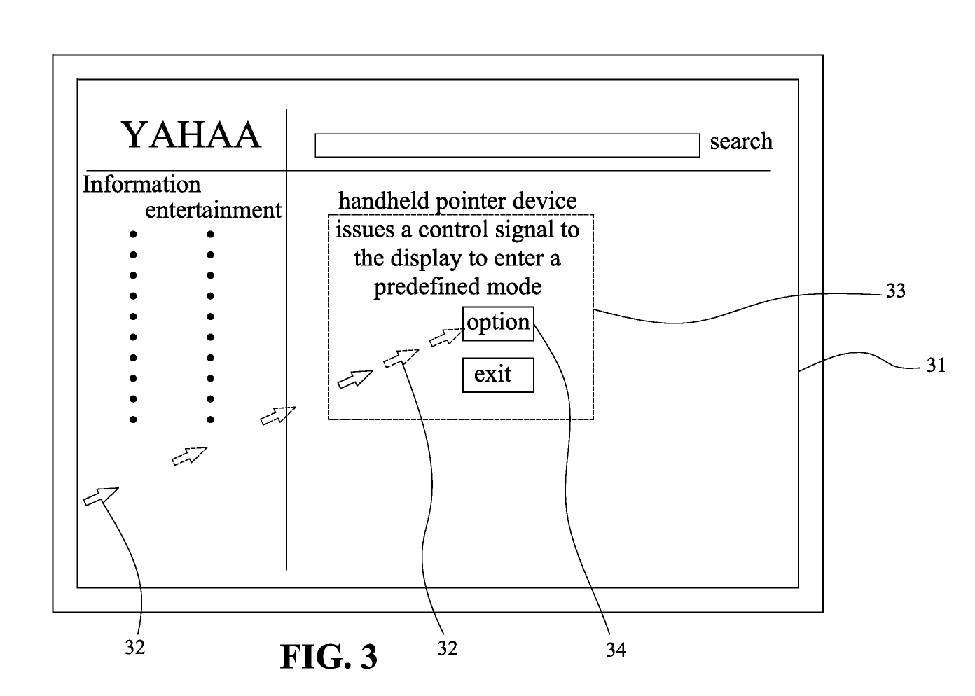

As aforementioned, when executing a predefined mode, the display will activate either a slow cursor movement mode or an enlargement mode automatically or manually in addition to select a rectangular area inside the operation screen. The following describes the two modes. FIG. 3 shows a schematic view of the execution of a slow cursor movement mode under the operation screen 31 in a predefined mode. The slow cursor movement mode is the mode where the movement speed of cursor 32 of the handheld pointer device is reduced when cursor 32 is detected to be within rectangular area 33. The slow movement can be accomplished by different means. The following only describes an embodiment, and other equivalent means of embodiments are also within the scope of the present invention. In this embodiment, the present invention changes the resolution set in the handheld pointer device from mapping to the resolution of the operation screen to mapping to the resolution of the rectangular area. In this manner, for example, when the handheld pointer device moves 12 units in distance under absolute coordination, the actual movement distance may change from 12 centimeters when mapped to a 30-in display screen to 2 centimeters when mapped to a 5-in rectangular area. Hence, the cursor appears moving slower. In other words, when cursor 32 enters rectangular area 33, the present invention assumes that the cursor is now close to target object 34 within the rectangular area and slows the cursor down to approach the target object. In this case, cursor 32 will not exhibit large distance movement even if the handheld pointer device experience minor trembling from the user hand. Therefore, cursor 32 can easily be pointed to locate target object 34. The slow cursor movement mode can be automatically activated when operation screen 31 selects rectangular area 33. Alternatively, the user can use the handheld pointer device to issue a control signal to indicate the activation or exiting of the slow cursor movement mode.

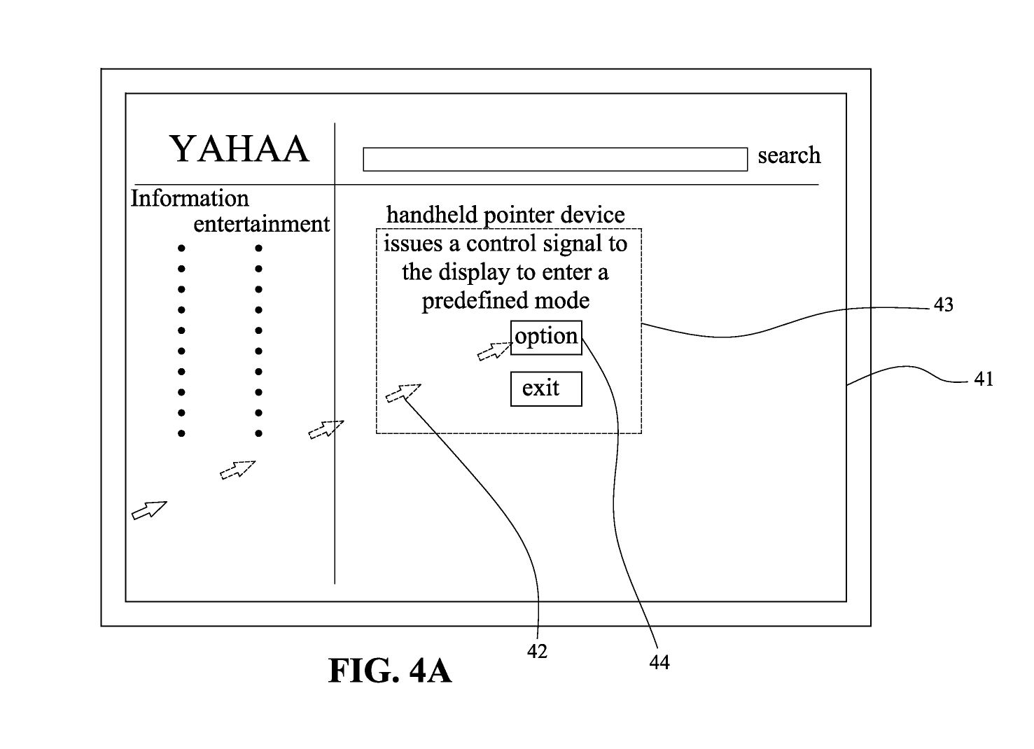

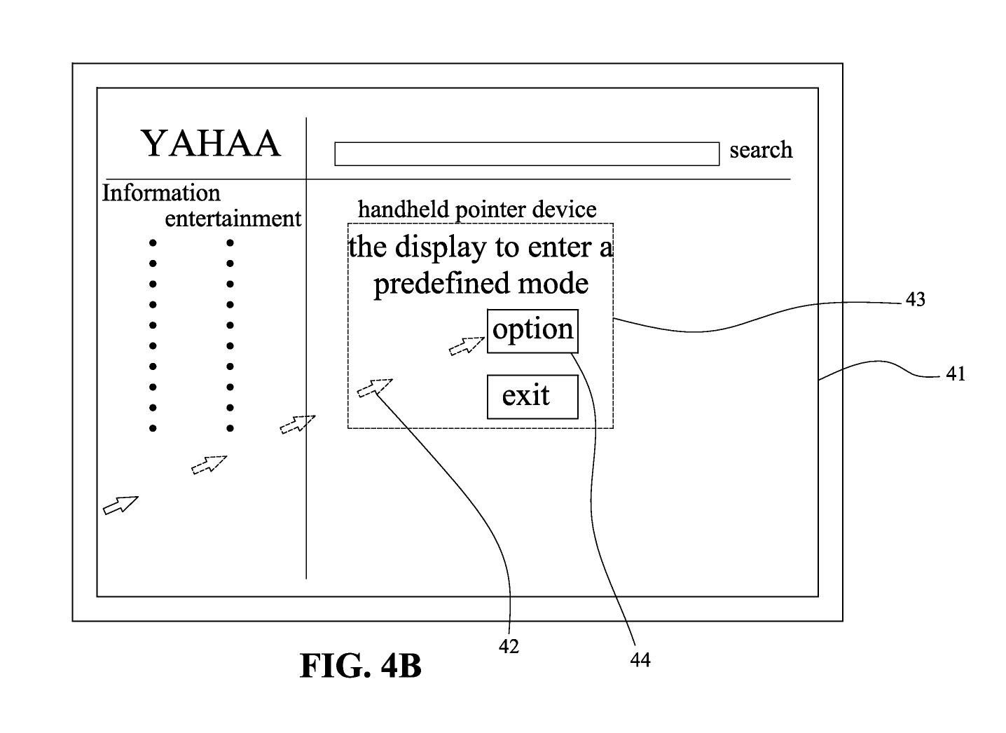

FIGS. 4A-4B show a schematic view of the execution of an enlargement mode under the operation screen 41 in a predefined mode. The enlargement mode is to enlarge the view of the contents of rectangular area 43, and the enlargement ratio can be predefined or controlled via the buttons of handheld pointer device. The enlargement mode is the mode when be executed at the time when operation screen 41 selects rectangular area 43, or when cursor 42 of handheld pointer device is detected to enter rectangular area 43. Because target object 44 inside rectangular area 43 is enlarged when the rectangular area 43 is enlarged, cursor 42 can select target object 44 more easily.

In addition, aforementioned step 203 is for the display to receive and execute all types of control signals, such as, control signals to execute slow cursor movement mode or enlargement mode in the predefined mode from the handheld pointer device. Therefore, the user can execute each of the modes individually or execute two or more modes at the same time, for example, executing both enlargement mode and slow cursor movement mode, so that the cursor can move slowly within the enlarged rectangular area to further facilitate ease selection of the target object and minimize the impact on the handheld pointer device operation caused by minor trembling or button pressing.

In summary, the present invention is to select a rectangular area in an operation screen via a handheld pointer device with the cursor as the reference point. Acting in concert with the execution of a slow cursor movement mode or an enlargement mode, the present invention allows the cursor to easily locate and select the target object within the rectangular area to minimize the impact on the handheld pointer device operation caused by minor trembling or button pressing.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A method of improving operation of a handheld pointer device in an display screen, applicable to a handheld pointer device and a display screen, said display screen being able to display a cursor indicating the location of said handheld pointer device, said method comprising the steps of:
said handheld pointer device issuing a control signal of entering a predefined mode to said display;
said display receiving said control signal of entering a predefined mode and activating said predefined mode, said predefined mode further comprising selecting a rectangular area, said rectangular area being a part of an operation screen displayed on said display, said rectangular area covering location of said cursor when said handheld pointer device issuing said control signal of entering a predefined mode;
said display receiving and executing each of control signals issued by said handheld pointer device in said predefined mode; and
determining whether to exit said predefined mode based on execution result of previous step.

2. The method as claimed in claim 1, wherein said predefined mode further comprises a slow cursor movement mode, said slow cursor movement mode is a mode where the movement speed of said cursor is reduced when said cursor is detected to be within said rectangular area so that said cursor is easier to select a target object within said rectangular area.

3. The method as claimed in claim 1, wherein said predefined mode further comprises an enlargement mode, said enlargement mode is a mode where a view of contents within said rectangular area is enlarged so that said cursor is easier to select a target object within said rectangular area.

4. The method as claimed in claim 1, wherein said predefined mode further comprises an enlargement mode, said enlargement mode is a mode where a view of contents within said rectangular area is enlarged when said cursor is detected to be within said rectangular area so that said cursor is easier to select a target object within said rectangular area.

5. The method as claimed in claim 3, wherein the enlargement ration of said enlargement mode can be adjusted by a control signal issued by said handheld pointer device.

6. The method as claimed in claim 1, wherein the size of said enlargement mode can be adjusted by a control signal issued by said handheld pointer device.

7. The method as claimed in claim 1, wherein said display receives a control signal of exiting predefined mode from said handheld pointer device and exits said predefined mode.

8. The method as claimed in claim 1, wherein said display receives a control signal of selecting an target object within said rectangular area from said handheld pointer device, then exits said predefined mode and executes a function associated with said target object.

9. The method as claimed in claim 1, wherein said display is one of television, computer monitor or projector screen.
